(19) United States
(12) Patent Application Publication
(10) Pub. No.: US 2008/0038444 A1
(43) Pub. Date: Feb. 14, 2008

(54) Process for the preparation of shrimp product

(76) Inventor: Hann-Kuang Chen, Kaohsiung City (TW)

Correspondence Address: SEYFARTH SHAW LLP, 131 S. DEARBORN ST., SUITE2400, CHICAGO, IL, 60603-5803, US

(21) Appl. No.: 11/501,313

(22) Filed: Aug. 9, 2006

(51) Int. Cl. A23L 1/325

(52) U.S. Cl. 426/643

(57) ABSTRACT

A process for the preparation of a shrimp product includes the steps of: (a) preparing first and second raw shrimps; (b) decapitating and removing all of the shell from the first raw shrimp; (c) decapitating and removing all but a tail segment of the shell from the second raw shrimp; (d) forming a cutting slit in a head portion of the second raw shrimp; (e) extending a tail portion of the peeled first raw shrimp into the cutting slit in the head portion of the second raw shrimp; (f) applying an edible binder to the contact area between the head portion of the peeled second raw shrimp and the tail portion of the peeled first raw shrimp so as to bind the first and second raw shrimps together to form a composite product; and (g) freezing the composite product.

### BACKGROUND OF THE INVENTION

1. Field of the Invention

This invention relates to a process for the preparation of a shrimp product, more particularly to a process for the preparation of a shrimp product which includes interconnected first and second raw shrimps.

2. Description of the Related Art

U.S. Pat. No. 5,846,586 discloses a composite seafood product that includes a series of interconnected raw shrimps, which can simulate the appearance of a large shrimp having a long body. Each of the raw shrimps is formed with a butterfly slit which configures the raw shrimp into two butterfly portions. An opening is formed at the juncture of the two butterfly portions of each of the raw shrimps. A tail portion of each raw shrimp is inserted fittingly through the opening in an adjacent one of the raw shrimps so as to hold the raw shrimps together.

The aforesaid composite seafood product is disadvantageous in that formation of the same is laborious.

The entire disclosure of U.S. Pat. No. 5,846,586 is incorporated herein by reference.

### SUMMARY OF THE INVENTION

Therefore, it is an object of the present invention to provide a process for the preparation of a frozen and peeled shrimp product that is capable of overcoming the aforesaid disadvantage of the prior art.

Accordingly, a process for the preparation of a frozen and peeled shrimp product of the present invention comprises the steps of: (a) preparing first and second raw shrimps; (b) decapitating and removing all of the shell from the first raw shrimp; (c) decapitating and removing all but a tail segment of the shell from the second raw shrimp; (d) forming a cutting slit in a head portion of the second raw shrimp; (e) extending a tail portion of the peeled first raw shrimp into the cutting slit in the head portion of the second raw shrimp; (f) applying an edible binder to the contact area between the head portion of the peeled second raw shrimp and the tail portion of the peeled first raw shrimp so as to bind the first and second raw shrimps together to form a composite product; and (g) freezing the composite product.

### BRIEF DESCRIPTION OF THE DRAWINGS

In drawings which illustrate embodiments of the invention,

FIG. 1 is a flow diagram to illustrate consecutive steps of the first preferred embodiment of a process for the preparation of a shrimp product according to the present invention;

FIG. 2 is a perspective view to illustrate how first and second raw shrimps are connected to each other in a mold according to the first embodiment of this invention;

FIG. 3 is a schematic view to illustrate how the first and second raw shrimps of FIG. 2 are formed into a composite product according to the first embodiment of this invention;

FIGS. 4 and 5 are perspective views to illustrate consecutive steps of the second embodiment of the process of this invention;

FIG. 6 is a perspective view of the third embodiment of the process of this invention modified from the second embodiment; and

FIG. 7 is a perspective view of the fourth embodiment of the process of this invention.

### DETAILED DESCRIPTION OF THE PREFERRED EMBODIMENTS

For the sake of brevity, like elements are denoted by the same reference numerals throughout the disclosure.

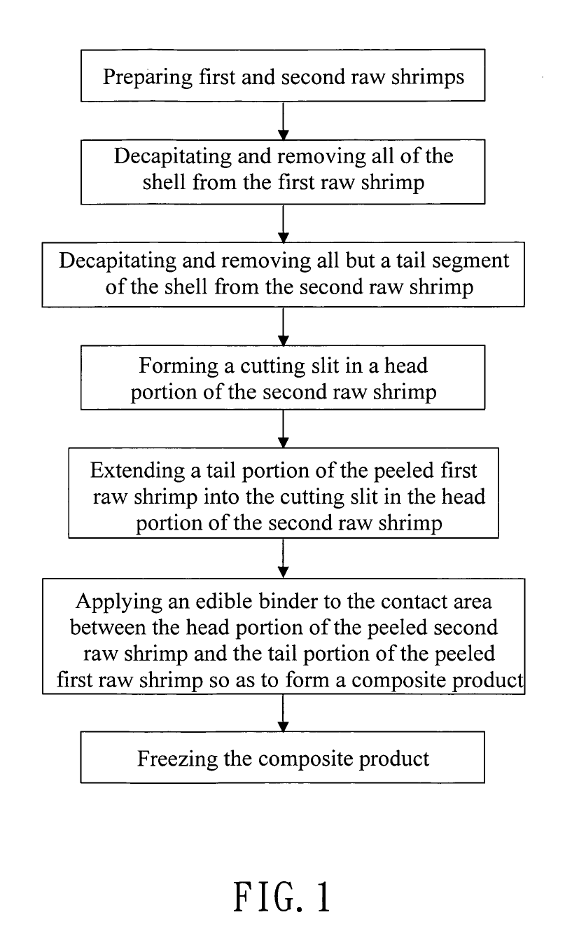

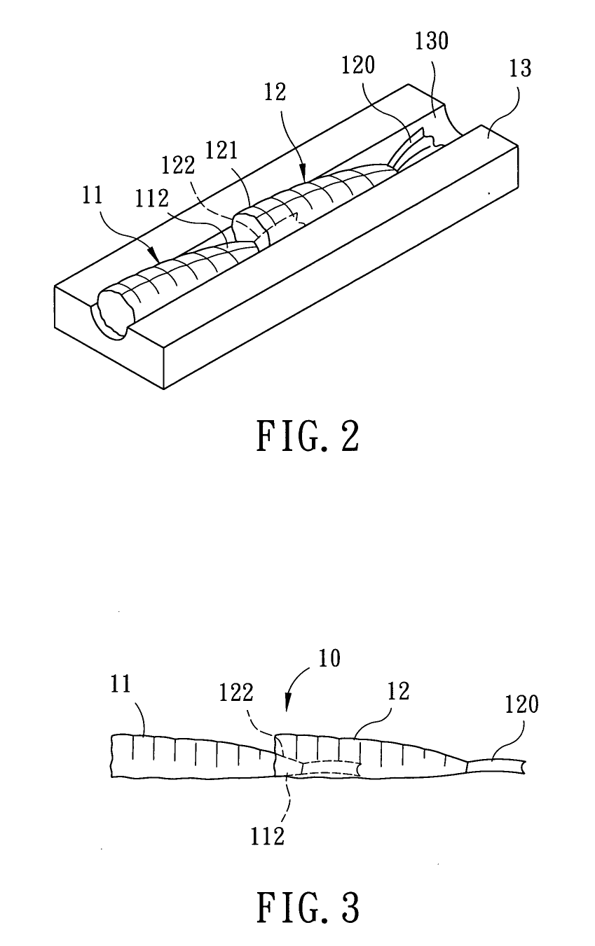

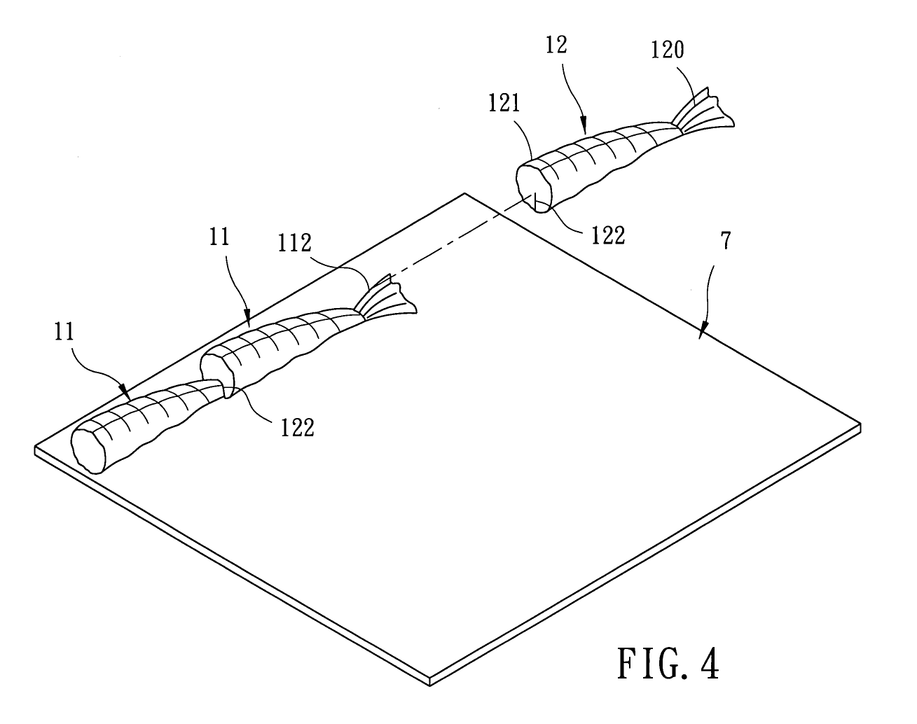

FIG. 1 illustrates a flow diagram of the first preferred embodiment of a process for the preparation of a frozen and peeled shrimp product according to the present invention. The process of this invention includes the steps of: (a) preparing first and second raw shrimps 11, 12; (b) decapitating and removing all of the shell from the first raw shrimp 11 (see FIG. 2); (c) decapitating and removing all but a tail segment 120 of the shell from the second raw shrimp 12 (see FIG. 2); (d) forming a cutting slit 122 in a head portion 121 of the second raw shrimp 12 (see FIG. 2); (e) placing the first and second raw shrimps 11, 12 in a cavity 130 in a mold 13 (see FIG. 2) in such a manner that a tail portion 112 of the peeled first raw shrimp 11 extends into the cutting slit 122 in the head portion 121 of the second raw shrimp 12 (see FIGS. 2 and 3); (f) applying an edible binder to the contact area between the head portion 121 of the peeled second raw shrimp 12 and the tail portion 112 of the peeled first raw shrimp 11 so as to bind the first and second raw shrimps 11, 12 together to form a composite product 10; and (g) freezing the composite product 10.

The edible binder suitable for binding the first and second raw shrimps 11, 12 preferably contains 70 wt % of egg albumin, 25 wt % of salt, and 5 wt % of polysaccharide.

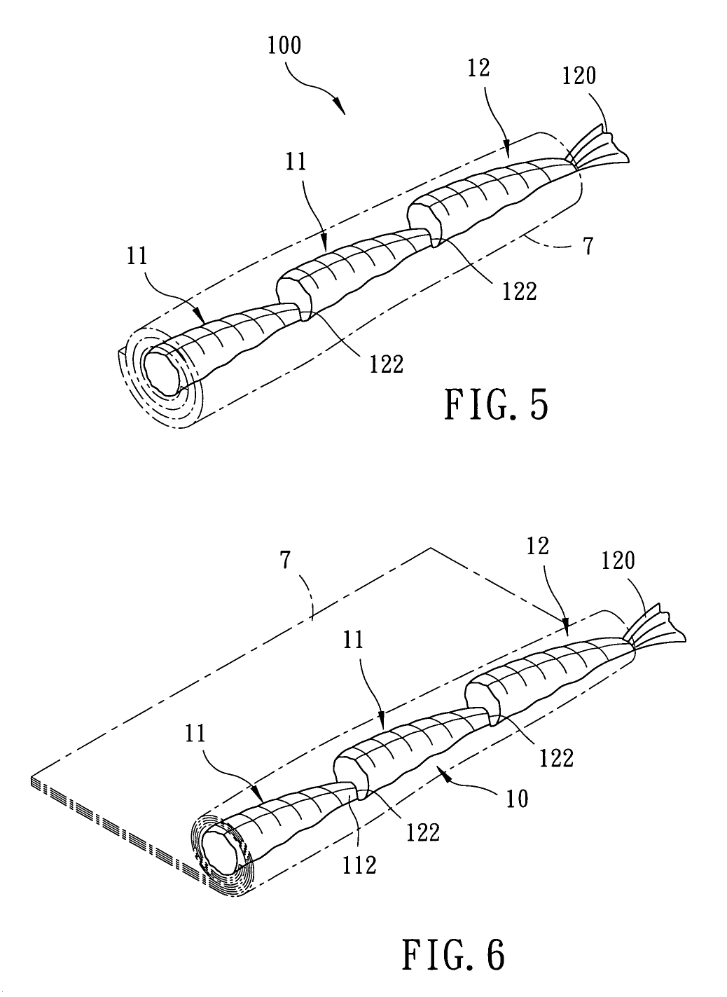

FIGS. 4 and 5 are perspective views to illustrate consecutive steps of the second embodiment of the process of this invention. The process of the second embodiment involves placing two of the first raw shrimps 11 and one second raw shrimp 12, which are formed and assembled together according to the aforesaid steps (a), (b), (c), (d), and (e), on an edible wrapper 7, subsequently wrapping the same with the edible wrapper 9 to form a shrimp roll 100, followed by freezing the shrimp roll 100. The edible wrapper 7 is preferably made from a cheese skin.

FIG. 6 illustrates the third embodiment of the process of this invention which differs from the second embodiment in that the edible wrapper 7 is made from a stack of flour-made skins.

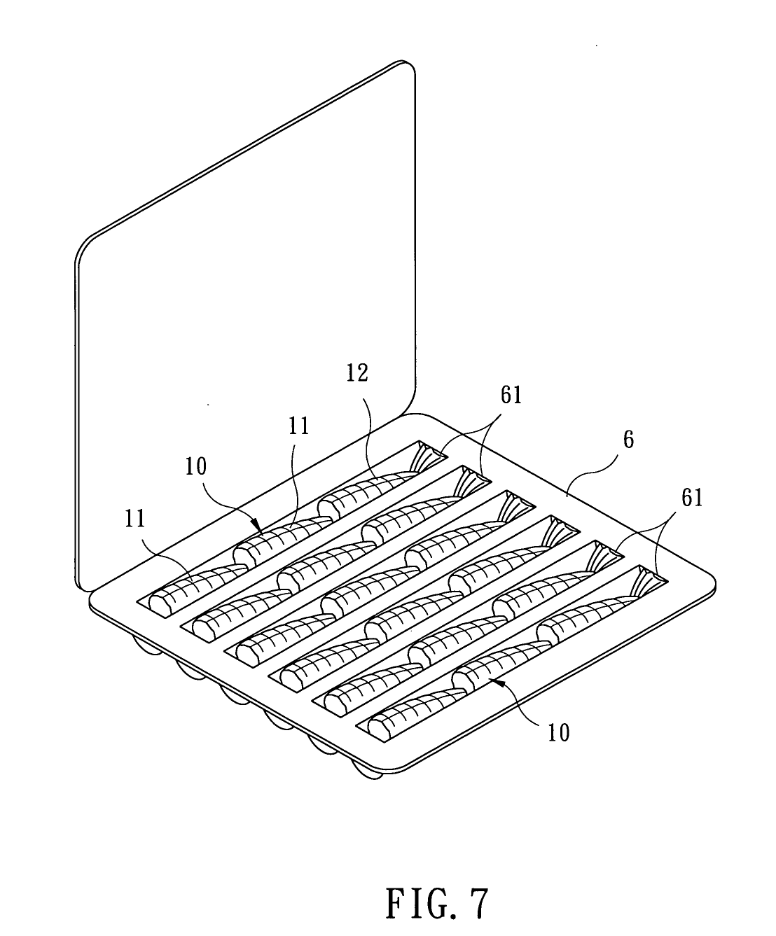

FIG. 7 illustrates the fourth embodiment of the process of this invention, which is similar to the first embodiment, except that a plurality of the composite products 10, each including two of the first raw shrimps 11 and one second shrimp 12, are formed and stored in retaining grooves 61 in a casing 6 prior to the aforesaid step (f).

Since the first and second raw shrimps 11, 12 of the composite product 10 are connected to each other by the edible binder, the aforesaid drawback as encountered in the prior art can be eliminated.

With the invention thus explained, it is apparent that various modifications and variations can be made without departing from the spirit of the present invention. It is therefore intended that the invention be limited only as recited in the appended claims.

I claim:

1. A process for the preparation of a frozen and peeled shrimp product, comprising the steps of:
(a) preparing first and second raw shrimps;
(b) decapitating and removing all of the shell from the first raw shrimp;
(c) decapitating and removing all but a tail segment of the shell from the second raw shrimp;
(d) forming a cutting slit in a head portion of the second raw shrimp;
(e) extending a tail portion of the peeled first raw shrimp into the cutting slit in the head portion of the second raw shrimp;
(f) applying an edible binder to the contact area between the head portion of the peeled second raw shrimp and the tail portion of the peeled first raw shrimp so as to bind the first and second raw shrimps together to form a composite product; and
(g) freezing the composite product.

2. The process of claim 1, further comprising wrapping the composite product with an edible wrapper so as to form a shrimp roll prior to the step (g).

3. The process of claim 1, wherein the peeled first and second raw shrimps are placed fittingly in a cavity in a mold prior to the step (g).

4. The process of claim 1, further comprising packaging the composite product in a retaining groove in a casing prior to the step (g).

5. The process of claim 1, wherein the edible binder contains 70 wt % of egg albumin, 25 wt % of salt, and 5 wt % of polysaccharide.
